(19) United States
(12) Patent Application Publication
(10) Pub. No.: US 2003/0124256 A1
(43) Pub. Date: Jul. 3, 2003

(54) Omnishield process and product

(75) Inventors: John Scofield, Clarks Summit, PA (US); Gerald Scofield, Tafton, PA (US)

Correspondence Address: OBLON, SPIVAK, MCCLELLAND, MAIER & NEUSTADT, P.C., 1940 DUKE STREET, ALEXANDRIA, VA, 22314, US

(73) Assignee: OMNISHIELD, INC., Elmhurst, PA

(21) Appl. No.: 10/369,769

(22) Filed: Feb. 21, 2003

Related U.S. Application Data
(63) Continuation of application No. 09/827,898, filed on Apr. 9, 2001, now abandoned.
(60) Provisional application No. 60/195,327, filed on Apr. 10, 2000.

(51) Int. Cl. D03D 15/00; B05D 3/10

(52) U.S. Cl. 427/304; 442/187

(57) ABSTRACT

This invention pertains to a process for plating metal onto textile products, and the metal plated textile products made by this process. The process can employ an apparatus that is conventionally used for dyeing fabric.

### RELATED APPLICATIONS

This application claims priority to Provisional application No. 60/195,327, filed Apr. 10, 2000.

### BACKGROUND OF THE INVENTION

This invention pertains to a process for plating metal onto textile products, including for example in order to make them electrically conductive, to improve their antistatic properties, and/or to change their biologic properties. In a preferred embodiment an apparatus conventionally used for dyeing fabric is employed in the invention process. The plated textile products also make up a part of the invention.

### DISCUSSION OF THE BACKGROUND

Two basic types of plating are used to coat textile products, vapor deposition and electrochemical deposition. Vapor deposition involves sputtering particles from a sputtering source into a physical deposition chamber that is held in an ultra-high vacuum condition. Traditional electrochemical plating systems for textile fabric and filament products involve moving the material to be plated through a plating solution or layering the material loosely in the treating solutions. The combinations of fabric movement, fabric openness, and some agitation of the solutions, either by pumping or stirring, are used to exchange solution at the surface of the material to be plated.

U.S. Pat. No. 3,877,965, discloses a method for plating nylon with silver which comprises subjecting a fibrous nylon substrate to a sensitizing polyvalent metal salt bath, then washing the substrate with water, subjecting it to a bath of deionized water, removing it from the deionized water and squeezing excess water out of it, then allowing the resulting wet fibrous substrate to stand with periodic agitation, within an aqueous silver plating solution, rinsing the silver-coated fibrous substrate and drying it.

U.S. Pat. Nos. 4,645,574 and 4,645,573, disclose a method of continuously sequentially coating polyamide filaments with copper and silver which utilizes as a key step in the process the use of a wetter solution containing alcohol, a detergent and an ethylene oxide and propylene oxide copolymer surfactant. The plating step in these patents is conventional.

U.S. Pat. No. 4,362,779 discloses a process for silvering articles having a polyamide base which comprises subjecting the article to the action of a polyphenol reducing agent which also serves to swell the polyamide and then immersing the article in an ammoniacal silver nitrate solution.

U.S. Pat. No. 3,940,533, discloses a method of attaching metal compounds to articles of synthetic polymers, such as fibers, threads, films or other shaped articles to increase the electrical conductivity of the articles, comprising immersing the article in an aqueous solution of hydrogen sulfide followed by immersion in an aqueous solution of a metal salt.

U.S. Pat. No. 4,241,105, disclosed a method of plating the surface of a substrate such as nylon yarn, comprising coating the substrate with a solution of a silver-pyridine complex dissolved in a non-aqueous solvent, drying the substrate, immersing the substrate in a basic solution whereby the silver-pyridine complex is converted to a silver oxide, then reducing the silver oxide to metallic silver and then forming an adherent electrically conductive layer of metal by conventional electroless plating.

U.S. Pat. No. 4,404,105, discloses a process for producing crimped, metal coated filamentary materials comprising knitting a continuous filamentary material to form a knitted fabric and then immersing the knitted fabric in an aqueous bath of silver nitrate and formaldehyde to form an electrically conductive oxidatively stable and non-toxic metal coating on the knitted fabric.

These conventional methods suffer from the drawback of providing poor results. In the inventors' estimation, and after careful study, these drawbacks are believed to be due to the fact that in these prior art methods it is difficult to obtain uniform solution movement through the fiber matrix. It is a lack of uniformity and fabric distortion that the inventors believe can cause the appearance and physical properties of the prior art products to vary. This variation can adversely effect customer acceptance and product performance. However, to achieve adequate solution movement in the prior art setting, significant agitation of the material is required of the type that often damages and/or distorts delicate fabrics.

It is also known in the art to plate metal onto a substrate using ultrasonic energy by immersing a work piece to be plated in a metal bath, which is agitated by ultrasonic energy.

U.S. Pat. No. 3,698,408 discloses an ultrasonic, processing apparatus useful for subjecting a work piece to be treated to the action of extremely high intensity ultrasonic energy.

U.S. Pat. No. 3,969,544, discloses a method for plating aluminum work pieces in the presence of ultrasonic agitation wherein an aluminum work piece is disposed in a body of molten metal maintained at an elevated temperature while the molten metal is subjected to sonic or ultra sonic agitation.

U.S. Pat. No. 4,750,977, discloses a method of electrochemically plating a layer of platinum black onto a conductive substrate, such as a platinum electrode, comprising the steps of positioning a counter electrode and the conductive substrate in a platinum ion plating solution and passing an electric current through said counter electrode, conductive substrate and plating solution, while simultaneously subjecting the plating solution and the substrate to ultrasonic agitation.

As will be seen, the inventors have been able to use ultrasonic energy to advantage in their invention.

### OBJECTS OF THE INVENTION

One object of the invention is a process for plating textile products with metal which overcomes the above-noted problems in the art and optionally takes advantage of ultrasonic energy. Another object is the utilization of a conventional dyeing apparatus in effecting the invention method. Plated textile products are another object. Further objects will become apparent upon a reading of the invention, summarized below.

### SUMMARY OF THE INVENTION

The method according to the present invention comprises plating metal onto textile products such as fabrics, fibers, filaments, staple(a textile term referring to relatively short lengths of filament fibers: 1/10″ to 6″ in length), porous films or particles, preferably using an apparatus that is conventionally used for dyeing textiles. Invention plating is preferably accomplished by loading the textile product material to be plated on a holder or in a container and then uniformly pumping at least one plating solution through the materials. Here a “plating solution” is any solution used in the chemical (electrochemical) plating process being applied to the textile product. The textile product to be plated is preferably tightly wrapped or packed in or on the holder or container to minimize material movement. The tight wrapping or packaging also prevents the channeling of solutions when they are subsequently pumped through the bundle of material. This causes uniform or near uniform solution movement through the textile product (e.g., fiber matrix) which provides very good plating.

The present process preferably takes advantage of the basic mechanical technology involved in beam dyeing, stock dyeing, and package dyeing. These three processes have traditionally been used to color dye textile products.

A preferred embodiment of the present invention that is not known to have previously been employed in color dyeing textile products is the use of ultrasonic sound waves to improve penetration of the plating solution between adjacent fibers. The use of ultrasonic-sound waves improves the uniformity of the plating and keeps suspended solids in solution which tends to prohibit them from depositing of the surface of the fibers. The use of ultrasonic-sound waves also serves to break-up any air pockets which may be trapped within the textile product contributing to uniform solution movement through the material.

An apparatus for dyeing yarn, such as those disclosed in U.S. Pat. Nos. 5,461,889, 4,854,137, 4,727,611, 4,454,733, incorporated by reference herein in their entirety, may be used to plate the metal onto the textile product according to the invention process.

### DETAILED DESCRIPTION OF THE INVENTION

In the invention process a textile product to be plated is positioned on or in an apparatus and, for example, a first solution that is used to “sensitize” the substrate is applied (any plating solutions formulations, etc. can be used in the invention method in any order to provide a plated product). This sensitizing solution may comprise a water soluble salt of a polyvalent metal cation. For example, an aqueous solution of stannous chloride is commonly used for this purpose, although any composition known in the art to be used for this purpose may be used. A highly preferred solution is an aqueous solution comprising stannous chloride and HCL. The sensitizing solution is rinsed from the product, for example with water, and a metal plating solution is applied to the substrate. The metal plating solution can be any which is known in the art, such as those disclosed in U.S. Pat. Nos. 3,877,965, 4,042,737, 4,241,105, 3,940,533, 4,362,779, 4,645,573 and 4,645,574, all of which are incorporated by reference herein in their entirety and may be one which does not require a sensitizer solution. One preferred solution is comprised of silver nitrate, ammonia, water, surfactant, and defoamer. The substrate is then washed with dilute caustic soda at pH 11, rinsed and then dried. In a preferred embodiment, the plating solution is subjected to ultrasonic agitation as it is present in (e.g., forced up through) the dye apparatus.

The range of platable textile products useful herein is not limited and includes textile products made of cotton, nylon, polyester, rayon, and acrylic. The preferred product is nylon.

The invention will now be further explained with regard to preferred examples.

Demonstration Unit: 6″ Wide with 2.5″ Core.

For example, fabric that is 6 inches wide is put onto a perforated stainless steel spool that is 2.5 inches in diameter and 6 inches long. Approximately 50 yards of fabric is wrapped under tension onto this spool. A cap is put on the top of the spool and the spool is then mounted vertically to a coupling on the bottom of a tank. In one embodiment, a 0.5 ounces per square yard spun-bonded nylon fabric that is 6 inches wide is put onto a perforated stainless steel spool that is 2.5 inches in diameter and 6 inches long. Approximately 50 yards of this fabric is wrapped under tension onto the spool. A cap is put on the top of the spool and the spool is then mounted vertically to a coupling on the bottom of a tank. Preferably, this tank is constructed of a material that is compatible with the plating solutions and of a size that allows for complete immersion of the spool. Highly preferred tank construction material is polyethylene. Another configuration is to mount the spool horizontally. Solution is forced through the center of the tube via a pump, out through the perforations, and through the fabric. Preferably, different tanks are used for each different plating solution, etc. to avoid contamination and to improve handling efficiency. In a preferred embodiment, the first solution is a cleaning solution comprised of water and detergents (trisodium phosphate, 1 tablespoon per 20 liters, and Rite Scour, 1 tablespoon per 20 liters, manufactured by Rite Industries, Inc.). The cleaning solution is circulated through the fabric for 1 hour and then rinsed until the discharge is clear with deionized water. The second solution is an aqueous stannous chloride/HCl solution, where the concentration of stannous chloride is between 0.1% and 10% and the HCl is added on a weight ratio of 2 to 1 relative to the stannous chloride, that is circulated through the textile material for 5 to 60 minutes and then rinsed. The second solution is the plating solution that comprises silver nitrate (0.28 gm/gm of fabric), ammonia (0.22 gm/gm of fabric), formaldehyde (0.15 gm/gm of fabric), water (0.5 liters/gm AgNO3), and surfactant (0.27 gm/gm of fabric). This solution is circulated through the fabric until the silver is depleted or the concentration of silver stabilizes (e.g., no more silver is being deposited on the fabric). The fabric is then washed with dilute caustic soda at pH11, rinsed and then dried. The resultant fabric is impregnated with the silver metal such that the filaments comprising the fabric are plated or coated with silver and the silver is not just on the visible surface of the fabric. In this manner it is possible to plate for example up to 30% by weight of silver onto the fabric, including of course 25, 20, 15, 10, 5, 1, and less than 1% based on total weight. Plating amount and thickness depends on the amount of silver nitrate added to the plating solution relative to the total weight of textile material to be plated. This provides a fabric with low electrical resistivity. The actual level of resistivity is affected by the coating thickness of silver on the fibers of the fabric and by the construction of the fabric.

In another preferred embodiment, the fabric is wrapped on a perforated spool or beam that has 8 to 10 layers of a non-platable polyolefin fabric on its surface. While not bound by a particular theory, it is believed that the non-platable fabric acts as a distributor to aid in the uniform flow of the various solutions used in the process, through the target fabric, and also as a filter to minimize particle build up on the target fabric. The fabric wrapped beam is then mounted in a tank. Next, the textile is contacted with a cleaning solution containing TSP (1 tbsp per 20 l) and Rite Scour (1 tbsp per 20 l) and/or Marlowe Marvan Scour for one hour and then rinsed until the discharge is clear. Next, the textile product is exposed to a sensitizing solution containing 1% tin chloride dihydrate and 5% 20° Baume hydrochloric acid. Sensitizing solutions with stannous chloride dihydrate concentration as low as 0.1% and as high as 10% may also be used. The hydrochloric acid should be two liters per kilogram of tin chloride. The sensitizing solution is circulated through the fabric for 1-60 minutes and at temperature from 14-25° C. The preferred contact time is approximately 30 minutes. The sensitizing solution is then discharged and the fabric is thoroughly rinsed with water until no chloride ion is detected in the rinse water. The presence of chloride ion in the rinse water is determined by a visual test where a small quantity of silver solution is added to a sample of the rinse water. If no precipitate is observed, the level of chloride present in the solution is acceptable.

The proper amount of rinsing after the sensitization step is important for good results. Insufficient rinsing can result in precipitation of silver when the plating solution is added to the tank. Precipitation of silver from the metal plating bath also reduces the quantity of dissolved silver that can actually be plated onto the fabric. However, excessive rinsing results in slow plating and poor quality of the plated fabric, as measured by electrical resistance and adhesion of the silver to the fabric. Excessive rinsing can be caused by failure to stop the rinsing process after the rinse solution is detected to be free of chloride ion and/or because the flow rate of the rinsing solution is too high. The optimal flow rate of rinse solution through the fabric depends on the density of the wound fabric and the size of the perforated steel core, and can be determined by one of ordinary skill in the art based upon the description herein without undue experimentation.

The product on the perforated tube is then moved to a second tank. The fabric is then contacted with circulating deionized water to which a dispersing agent is added, followed by addition of a silver ammonia complex metal plating solution. Any commonly used dispersing agent may be used. Dispersing agents include ionic and no-ionic surfactants, for example, detergents. A preferred dispersing agent solution is ammonium lauryl sulfate at a concentration of about 10%. The textile is contacted with sufficient solution so that 1 liter of 10% ammonium lauryl sulfate solution is present per kilogram of silver nitrate in the plating solution. The silver/ammonia complex metal plating solution is prepared, for example, by dissolving silver nitrate in water and then adding ammonia until the solution becomes clear. Alternatively, 38% ammonia is added to silver nitrate such that 1 liter of ammonia solution is added per kilogram of silver nitrate, then acetic acid is added to adjust the solution to pH9.

A reducing solution is then slowly added to the plating solution to begin the plating process. The reducing solution is added at a rate sufficient to maintain a 10-20% molar excess of reducing agent over the quantity of silver plated from the solution. The reducing solution is prepared by diluting 37% formaldehyde with 5-10 parts water. Alternatively, any other reducing agent composition known in the art may be used for this purpose. For example, other reducing agents such as glyoxal and hydrazine sulfate can be used. The rate of plating upon addition of the reducing solution is significantly influenced by temperature.

The invention plating process preferably is carried out at any temperature between 10° C. and 45° C. More preferably, the plating bath temperature is about 20-45° C. If the plating solution is subjected to ultrasonic agitation, higher plating rates are observed. The plating solution is then discharged and the textile is rinsed until the discharge is clear. At this time any post treatment steps, such as treatment with caustic washes, antitarnish compounds, and lubricants can be performed.

Preferred textile products for the invention are lightweight fabrics (2-6 oz/sq. yd.) Nonwoven nylon fabrics, loop knit and fabrics with brushed surfaces are also preferred. Aplix Loop #110, a nylon loop knit fabric, is especially preferred. While the process described above can be carried out in one tank, in a preferred embodiment the scouring (cleaning) and sensitizing steps are carried out in a second tank.

In a preferred embodiment, where scouring is accomplished with, for example, Marlowe Marvan Scour LTS-42 the temperature of the solution is preferably about 130° F., and several cycles are used. For example, a one half hour scouring cycle followed by two rinsings with room temperature water followed by another half hour scouring yields good results.

A particularly preferred sequence of steps is as follows:

scouring with tap water and Marlowe Marvan Scour LTS-42 at about 130° F., rinsing with room temperature tap water, scouring again with tap water and the Marvan Scour at 130° F., rinsing with tap water, rinsing with deionized (DI) water at room temperature, carrying out sensitization, rinsing with DI water, plating, rinsing again with DI water at room temperature, followed by a caustic rinse with DI water and caustic preferably at a pH of 11 for approximately 20 minutes. A final rinse with DI water (if the product is intended for medical applications) or tap water (if the product is intended for electronic application) is accomplished at room temperature.

The invention may be embodied in other specific forms without departing from the spirit or essential characteristics thereof. The present embodiments are to be considered in all respects as illustrative and not restrictive, the scope of the invention being indicated by the appended claims rather than by the foregoing description and all changes which come within the meaning and range of equivalency of the claims are intended to be embraced therein.

What is claimed is:

1. A method for applying a metal-coating to a textile product which comprises:
wrapping or packing the textile product on or in a holder or container which has perforations;
optionally forcing a sensitizing solution through said perforations and said product; and
forcing a metal plating solution through said perforations and said product to provide a metal coated textile product.

2. The method of claim 1, further comprising rinsing and drying the metal coated textile product.

3. The method of claim 1, wherein said sensitizing solution and plating solution are applied under a sufficient pressure to thoroughly impregnate the product with the solutions, and wherein said solutions are forced first through said perforations and then into said product.

4. The method according to claim 1, wherein said sensitizing solution is rinsed from the product prior to application of the metal plating solution to the product.

5. The method according to claim 1, wherein the plating solution comprises silver nitrate, ammonia, water surfactant and defoamer.

6. The method according to claim 1, wherein said container or holder is a capped perforated cylinder and said metal plating solution is forced up through the cylinder, out through the perforations and into the product.

7. The method according to claim 1, wherein the metal plating solution is subjected to ultrasonic energy as it is forced through said product.

8. The method according to claim 1, wherein the sensitizing solution comprises a polyvalent metal cation.

9. The method of claim 8, wherein the cation is Sn (II) or Sn(III).

10. The method according to claim 1, wherein the product is a delicate fabric susceptible to distortion.

11. A method for applying a metal-coating to a textile product which comprises:
wrapping or packing the product on or in a holder or container which has perforations;
applying a scouring agent solution comprising a mixture of surfactant and a sequestering agent to said product;
applying a sensitizing agent solution comprising a salt of a polyvalent metal cation to said product;
applying a metal plating solution to said product;
applying a reducing solution to said product to form a metal coated product; and
rinsing and drying the metal coated product, wherein said sensitizing solution and plating solution are applied under a sufficient pressure to thoroughly impregnate the fiber or fabric with the solutions.

12. The method according to claim 11, wherein the reducing solution comprises water, and a reducing agent selected from the group consisting of formaldehyde, glyoxal, and hydrazine sulfate.

13. The method according to claim 11, wherein the surfactant is selected from the group consisting of ionic surfactants and nonionic surfactants.

14. The method according to claim 13, wherein the sequestering agent is trisodium pyrophosphate.

15. The method according to claim 11, wherein the metal plating solution is subjected to ultrasonic energy as it is applied to the product.

16. A metal coated textile product made by a process comprising:
(a) wrapping or packing the product on a cylindrical container which has perforations;
(b) applying a sensitizing agent solution comprising a salt of a polyvalent metal cation to said product;
(c) applying a metal plating solution to said product to form a metal coated product; and
rinsing and drying the metal coated product, wherein said sensitizing solution and plating solution are applied under a sufficient pressure to throughly impregnate the product with the solutions.

17. A metal coated textile product made by the method of claim 1.

18. A metal coated textile product made by the method of claim 11.
